(19) United States
(12) Patent Application Publication
(10) Pub. No.: US 2004/0097150 A1
(43) Pub. Date: May 20, 2004

(54) Blister fabrics with internal connecting elements

(76) Inventors: William O. Boyd JR., Spartanburg, SC (US); John T. Tucker, Greenwood, SC (US); David M. Brown, Greenville, SC (US); Iain R. Taylor, Ramsbottom (GB); Derek Sharpe, Taylors, SC (US)

Correspondence Address: Jeffery E. Bacon, Legal Department, M-495, PO Box 1926, Spartanburg, SC, 29304, US

(21) Appl. No.: 10/298,476

(22) Filed: Nov. 15, 2002

(51) Int. Cl. B32B 5/26; D03D 15/00; D03D 25/00

(52) U.S. Cl. 442/239; 442/304; 442/312; 442/318

(57) ABSTRACT

A blister fabric formed of a double layer jersey knit which is needled to produce internal connections of filaments and/or fibers from yarns extending into, and/or between, the yarns of an adjacent layer.

### BACKGROUND

The present invention relates to fabrics having internal connecting elements to help stabilize the fabric construction.

Many methods have been used to stabilize the construction of a knit or woven fabric. Coatings have been applied to prevent the yarns from moving. However, coatings alone may not give the fabric the additional desired characteristics. Recently, a process known as hydroentanglement has been employed to provide stabilization to woven fabrics. Hydroentanglement uses fluid jets to force fibers extending from the main body of a yarn to entangle with fibers extending from the main body of another yarn. However, hydroentanglement can sometimes affect the aesthetic characteristics of the fabric due to the large number of free fibers needed to create entanglements by the fluid jets. Therefore, there is a need for fabrics that have been stabilized by other methods, and the particular methods for stabilizing the fabrics.

### BRIEF DESCRIPTION OF THE DRAWINGS

FIG. 1 is a top view of a blister fabric illustrating one embodiment of the present invention;

FIG. 2 is an enlarged cross sectional view of the blister fabric from FIG. 1, taken about the section lines 2-2.

FIG. 3 is an enlarged cross sectional view of another embodiment of the present invention, using a composite of two separate layers of fabric.

FIG. 4 is an enlarged partial view of a needle used in the present invention.

FIGS. 5A and 5B are diagrams illustrating stitches used in one example of the present invention.

### DETAILED DESCRIPTION

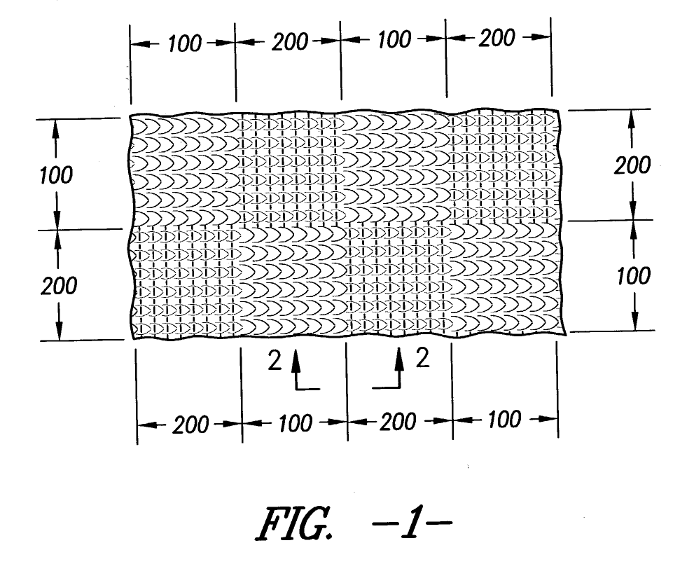

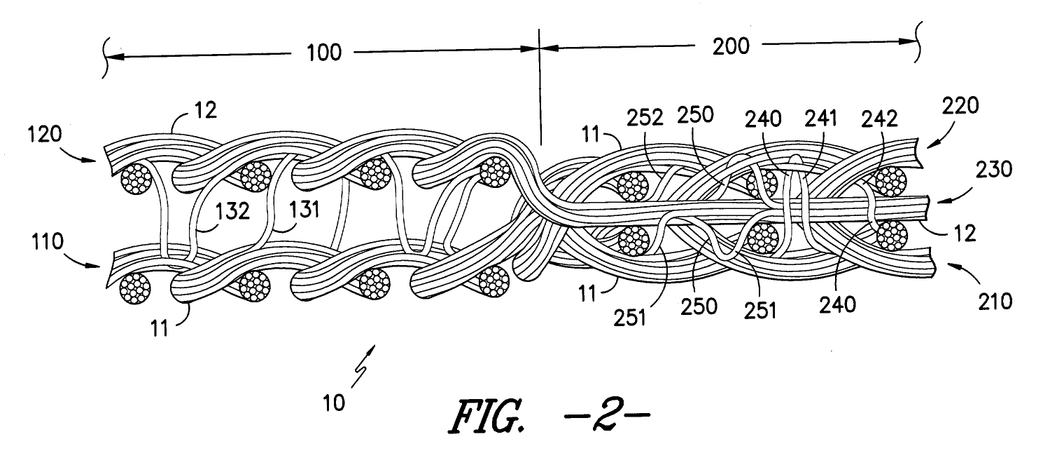

Referring now to the figures, and in particular FIGS. 1-2, there is shown a blister fabric 10 illustrating one embodiment of the present invention. The blister fabric 10 has alternating zones of blister zones 100 and base zones 200. The blister zones 100 have a lower blister layer 110 of a first material independent of an upper blister layer 120 of a second material. The base zones 200 are a unified layer of material.

As illustrated, the blister fabric 10 is formed of base yarns 11 and blister yarns 12. In one embodiment, the blister fabric 10 is formed from yarns having a size of up to about 600 denier. In another embodiment, the blister fabric 10 is formed from yarns having a size of at least about 15 denier. In one preferred embodiment, the fibers forming the base yarns 11 and the blister yarns 12 can both comprise filament yarns. As used herein, filament yarns includes multifilament yarns. In another embodiment, the base yarns 11 and the blister yarns 12 can both comprise spun yarns. In yet another embodiment, the base yarns 11 can comprise filament yarns and the blister yarns 12 can comprise spun yarns. In yet another embodiment, the base yarns 11 can comprise spun yarns and the blister yarns 12 can comprise filament yarns. It is also contemplated that the present invention will work with yarns of combined filament and staple fiber. The combined filament and staple fiber yarns can be used in the base yarns 11 and/or the blister yarns 12 as a substitute for either the filament yarns and/or spun yarns in the above combinations. The fibers of the filament and/or spun yarns in the present invention can be formed from natural or manufactured material. For example, natural materials can include materials of animals, vegetable, or mineral origin which are used as fibers. Manufactured materials can include polymers synthesized from chemical compounds, modified or transformed natural polymers and minerals.

Still referring to FIGS. 1-2, as illustrated, the lower blister layer 110 of the blister fabric 10 is a jersey knit of the base yarns 11, and the upper blister layer 120 of the blister fabric 10 is a jersey knit of the blister yarns 12. Also as illustrated, the base yarns 11 form a unified double layer jersey knit in the base zones 200, and the blister yarns 12 are sandwiched between the unified double layer jersey knit of the base yarns 11 in the base zones 200. Although the blister fabric 10 is illustrated as an all knitted fabric, it is contemplated that the blister fabric can be a woven fabric, or a combination of knit and woven fabric. Additionally, although the unified base zones 200 are illustrated as a knitted together section, it is contemplated that the unified base zones could be formed by processes such as weaving, stitching, bonding, or the like.

Referring now to FIG. 2, there is shown an enlarged cross sectional area of the blister fabric 10. As illustrated, blister zone connections 130 are formed between the lower blister layer 110 and the upper blister layer 120 by portions of the fibers from the yarns in one layer of the blister zone 100 passing from those yarns into, and/or between, the yarns of the other layer of the blister zone 110. Lower blister layer connections 131 are formed between the lower blister layer 110 and the upper blister layer 120 by portions of the fibers from the yarns in the lower blister layer 110 passing from those yarns into, and/or between, the yarns of the upper blister layer 120. Upper blister layer connections 132 are formed between the upper blister layer 120 and the lower blister layer 110 by portions of fibers from the yarns in the upper blister layer 120 passing from those yarns into, and/or between, the yarns or of the lower blister layer 100. The lower blister layer connections 131 and the upper blister layer connections 132 provide a securing tie between the lower blister layer 110 and the upper blister layer 120.

Still referring to FIG. 2, a fiber forming one of the lower blister layer connections 131 originates from a yarn in the lower blister layer 110 and then projects into the upper blister layer 120. The fibers from the lower blister layer 110 forming the lower blister layer connections 131 are secured by the fibers or filaments in the main body of the yarns in the upper blister layer 120. A portion of the fibers forming the lower blister layer connections 131 are secured between fibers within the main body of the yarns in the upper blister layer 120, the main body being the group of fibers which are oriented in about the same direction as the yarn itself. Another portion of the fibers forming the lower blister layer connections 131 are secured between yarns of the upper blister layer 120 by the fibers in the main body of those yarns. A fiber forming one of the upper blister layer connections 132 originates from a yarn in the upper blister layer 120 and then projects into the lower blister layer 110. The fibers from the upper blister layer 120 forming the upper layer connections 132 are secured by the fibers or filaments in the main body of the yarns in the lower blister layer 110. A portion of the fibers forming the upper blister layer connections 132 are secured between fibers within the main body of the yarns in the lower blister layer 110, the main body being the group of fibers which are oriented in about the same direction as the yarn itself. Another portion of the fibers forming the upper blister layer connections 132 are secured between yarns of the lower blister layer 110 by the fibers in the main body of those yarns. These types of connections contrast with connections formed between yarns and layers by the entanglement of fibers extending generally outward and at least partially radial from one yarn with the fibers extending in a direction generally outward and at least partially radial from another yarn, as experienced with many of the hydroentanglement methods of treating a fabric.

Many of the lower blister layer connections 131 and the upper blister layer connections 132 are loops of the fibers from the respective source layers that insert into the corresponding receiving layers. The loops of fibers create two connections, each of the connections being one half of the loop that originates in the same yarn and then project into the same receiving layer. In some instances, the upper blister layer connections 131 and/or the lower blister layer connections 132 can be formed by sections of the fibers that are attached at only one end to the respective source yarns. In some further instances, a fiber attached at only one end and forming an upper blister layer connection 131 or a lower blister layer connection 132 can be hooked, bent, or looped at the free end to further secure with the fibers of the corresponding layer to which the connection engages.

In one embodiment, the blister zone of a fabric incorporating the present invention, has a total of at least about 275 total connections (the total of both the connections originating from a particular layer and the connections received by that particular layer) per square inch securing the lower blister layer to the upper blister layer, and a maximum of about 520,000 total connections per square inch, depending on the stability needed and the construction of the fabric. In one preferred embodiment, the blister zone has a total of from about 350 total connections per square inch to about 1.050 total connections per square inch, and more preferably about 750 total connections per square inch.

Because the source of the connections comes from within yarns, and the connections also secure yarns, it is helpful to understand the number of total connections (the total of both connections originated from a particular yarn and the connections received by that particular yarn) per yarn distance. In one embodiment, the yarns that form the upper blister layer or the upper blister layer in the blister zone of the fabric incorporating the present invention, have a minimum of at least about 1.1 total connections per yarn-inch securing the yarn, and a maximum of about 1.650 total connections per yarn-inch. In one preferred embodiment, the yarns that form the lower blister layer or the upper blister layer of the blister zone of the fabric incorporating the present invention, have from about 1.4 total connections per yarn-inch to about 4.2 total connections per yarn-inch, and more preferably about 2.8 total connections per yarn-inch.

Because the fibers of the yarn are the source of the connections, different yarns will have different availability of fibers for the connection, and different needs for the amount of connections based on the fiber content of the yarn. A measurement of filament-distance is length of a yarn having filament(s) multiplied by the number of filaments in that yarn bundle. Therefore, it is helpful to understand the number of total connections (the total of both connections originated from a particular yarn and the connections received by that particular yarn) per filament distance of the yarns for the portion of the fabric incorporating the present invention. In one embodiment, the yarns that form the lower blister layer or the lower blister layer in the blister zone, have at least about 0.02 total connections per filament-inch, and a maximum of about 6.4 total connections per filament-inch. In one preferred embodiment, the yarns that form the upper blister layer or the lower blister layer of the blister zone have from about 0.022 total connections per filament-inch to about 0.07 total connections per filament-inch, and more preferably about 0.04 total connections per filament-inch.

Referring again to FIG. 2, the base zone 200 is a unitary construction with a lower base layer portion 210, an upper base layer portion 220, and trapped yarns 230 passing between the upper base layer portion 210 and the upper base layer portion 220. In the embodiment illustrated, the lower base layer portion 210 and the upper base layer portion 220 are-formed by the base yarns 11, and the blister yarns 12 form the trapped yarns 230 between the two layers. As illustrated, base layer connections 240 are formed between the lower base layer portion 210 and the upper base layer portion 220. Also, trapped yarn connections 250 are formed between the lower base layer 210 and the trapped yarn 230 and the upper base layer portion 220 and the trapped yarn portion 230.

Referring still to FIG. 2, similar to the blister zone connections 230, the base layer connections 240 are formed between the lower base layer 210 and the upper base layer 220 by portions of the fibers from the yarns in one layer of the base zone 200 passing from those yarns into the other layer of the base zone 200. Lower base layer connections 241 are formed by fibers that originate from a yarn in the lower base layer 210 and then project into and/or between, the yarns of the upper base layer 220. The fibers from the lower base layer 210 forming the lower base layer connections 241 are secured by the fibers or filaments in the main body of the yarns in the upper base layer 220. A portion of the fibers forming the lower base layer connections 241 are secured between fibers within the main body of the yarns in the upper base layer 220, the main body being the group of fibers which are oriented in about the same direction as the yarn itself. Another portion of the fibers forming the lower base layer connections 241 are secured between yarns of the upper base layer 220 by the fibers in the main body of those yarns. Upper base layer connections 242 are formed by fibers that originate from a yarn in the upper base layer 220 and then project into the lower base layer 210. The fibers from the upper base layer 220 forming the upper base layer connections 242 are secured by the fibers or filaments in the main body of the yarns in the lower base layer 210. A portion of the fibers forming the upper base layer connections 242 are secured between fibers within the main body of the yarns in the lower base layer 210, the main body being the group of fibers which are oriented in about the same direction as the yarn itself. Another portion of the fibers forming the upper base layer connections 242 are secured between yarns of the lower base layer 210 by the fibers in the main body of those yarns. The lower base layer connections 241 and the upper base layer connections 242 provide a securing tie between the lower base layer 210 and the upper base layer 220.

As with the lower blister layer connections 131 and the upper blister layer connections 132, many of the lower base layer connections 241 and the upper base layer connections 242 are loops of the fibers in the respective source yarns that insert into the corresponding receiving layer. In some instances, the lower base layer connections 241 and/or the upper blister layer connections 242 can be formed by sections of the fibers that are attached at only one end to the respective source yarns. In some further instances, a fiber attached at only one end and forming a lower base layer connection 241 or an upper base layer connection 242 can be hooked, bent, or looped at the free end to further secure with the fibers of the corresponding receiving layer to which the connection engages. The base layer connections 240 provide a securing tie between the lower base layer 210 and the upper base layer 220, thereby giving the base zone 200 a more stabilized and abrasion resistant fabric.

In one embodiment, the base zone of a fabric incorporating the present invention has a total of at least about 57 total connections (the total of both the connections originating from a particular layer and the connections received by that particular layer) per square inch securing the lower base layer to the upper base layer, and a maximum of about 109,110 total connections per square inch, and more preferably about 150 total connections per square inch, depending on the stability needed and the construction of the fabric. In one embodiment, the yarns that form the lower base layer of the upper base area of the base zone of the fabric incorporating the present invention, have a minimum of at least about 0.6 total connections per yarn-inch securing the yarn, and a maximum of about 11.61 total connections per inch, and more preferably about 1.6 total connections per yarn-inch. In one embodiment, the yarns forming the connections have from about 28.8 connections per filament-inch to about 557 connections per filament-inch.

Still Referring to FIG. 2, the trapped yarn connections 250 are formed between the trapped yarns 230 and the lower base layer 210 and the upper base layer 220, by portions of the fibers from the trapped yarn 230 passing into, and/or between, the main body of the yarns in the lower base layer 210 or the upper base layer 220, and/or fibers from yarns in the lower base layer 210 or the upper base layer 200 passing into the trapped yarn 230. Lower base trapped yarn connections 251 are formed between the trapped yarns 230 and the lower base layer 210 by portions of the fibers from the yarns in the lower base layer 210 passing from those yarns into the main body of the trapped yarns 230, and by fibers from the trapped yarns passing from the trapped yarns 230 into, and/or between the main body of the yarns of the lower base layer 210. Upper base trapped yarn connections 252 are formed between the trapped yarns 230 and the upper base layer 220 by portions of the fibers from the yarns in the upper base layer 220 passing from those yarns into the main body of the trapped yarns 230, and by fibers from the trapped yarns 230 passing from the trapped yarns 230 into, and/or between, the main body of the yarns of the upper base layer 220.

As with the lower base layer connections 241 and the upper base layer connections 242, many of the lower base trapped yarn connections 251 and the upper base trapped yarn connections 252 are loops of the fibers in the respective source yarns that insert into the corresponding receiving yarns or layer. In some instances, the lower base trapped yarn connections 251 and/or the upper base trapped yarn connections 252 can be formed by sections of the fibers that are attached at only one end to the respective source yarns. In some further instances, a fiber attached at only one end and forming an lower base trapped yarn connection 251 or an upper base trapped yarn connection 252 can be hooked, bent, or looped at the free end to further secure with the fibers of the corresponding receiving yarn or layer to which the connection engages.

The trapped yarn connections 250 provide a securing tie between the trapped yarn 230 and the lower base layer 210, and the trapped yarn 230 and the upper base layer 220, thereby giving the base zone 200 a more stabilized and abrasion resistant fabric. In one embodiment, the yarns that form the trapped yarns of the base zone of the fabric incorporating the present invention, have a minimum of at least about 0.6 total connections per yarn-inch securing the yarn, a maximum of about 11.61 total connections per yarn-inch, and more preferably about 1.6 total connections per yarn-inch. In one embodiment, the trapped yarns have from about 28.8 connections per filament-inch to about 557 connections per filament-inch.

In one embodiment, the needled blister fabric 10 also includes a back coating disposed on the back side of the lower blister layer 110 and the lower base layer 210. It has been found that a backcoating further improves the abrasion resistance of the opposite side of the needled blister fabric 10. The back coating can be any polymeric material, such as latex, polyvinylacetate, or the like. The back coating can be applied at a level of from about 0.25 oz/yd² to about 5 oz/yd².

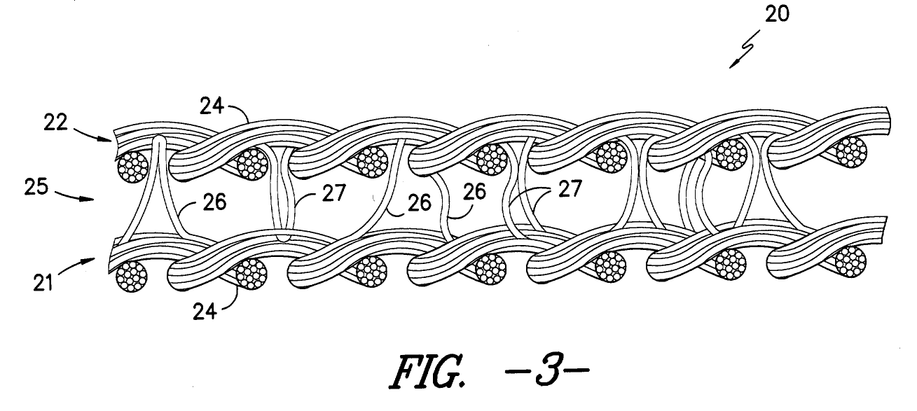

Referring now to FIG. 3, there is shown an enlarged cross section of a fabric composite 20 illustrating another embodiment of the present invention. The fabric composite 20 is a multiple layered cloth, such as a double cloth, a triple cloth, etc. The fabric comprises at least a first layer 21 and a second layer 22. At least one of the first layer 21 and the second layer is a knitted fabric. In the embodiment illustrated in FIG. 3, the first layer 21 is formed from first layer yarns 23, and the second layer 22 is formed from second layer yarns 24. In one embodiment, the first layer yarns 23 and/or the second layer yarns 24 have a yarn size of up to about 600 denier. In another embodiment, the first layer yarns 23 and/or the second layer yarns 24 have a yarn size of at least about 15 denier. In one preferred embodiment, both the first layer yarns 23 and the second layer yarns 24 comprise filaments. In another embodiment, the first layer yarns 23 are filament yarns and the second layer yarns 24 are spun yarns. In yet another embodiment, both the first layer yarns 23 and the second layer yarns 24 are spun yarns. Additionally, it is contemplated that first layer yarns 23 and/or the second layer yarns 24 can include yarns formed of the combination of filaments and staple fibers.

Connections 25 are formed between the first layer 21 and the second layer 22 by filaments of the yarns in the two layers. First layer connections 26 are formed by portions of the fibers in the first layer 21 that project into the second layer 22. The first layer connections 25 are secured by the fibers of the main body of the second layer yarns 24. Second layer connections 27 are formed by portions of the fibers in the second layer 22 that project into the first layer 21. The second layer connections 27 are secured by fibers of the main body of the first layer yarns 23. It is contemplated that the connections 25 of the present invention can be formed across the entire composite fabric 20, or in discrete zones.

Many of the first layer connections 26 and the second layer connections 27 are loops of the fibers from the respective source layers that insert into the corresponding receiving layers. The loops of fibers create two connections, each of the connections being one half of the loop that originates in the same yarn and then project into the same receiving layer. In some instances, the first layer connections 26 and/or the second layer connections 27 can be formed by sections of the fibers that are attached at only one end to the respective source yarns. In some further instances, a fiber attached at only one end and forming a first layer connection 26 or a second layer connection 27 can be hooked, bent, or looped at the free end to further secure with the fibers of the corresponding layer to which the connection engages.

In one embodiment, the composite fabric, or zone of the composite fabric incorporating the present invention, has a total of at least about 275 total connections (the total of both the connections originating from a particular layer and the connections received by that particular layer) per square inch securing the first layer to the second layer, and a maximum of about 520,000 total connections per square inch, depending on the stability needed and the construction of the fabric. In one preferred embodiment, there is a total of from about 350 total connections per square inch to about 1,050 total connections per square inch, and more preferably about 750 total connections per square inch.

In one embodiment, the yarns that form the first layer or the second layer of the composite fabric incorporating the present invention, have a minimum of at least about 1.1 total connections per yarn-inch securing the yarn, and a maximum of about 1,650 total connections per yarn-inch. In one preferred embodiment, these yarns have from about 1.4 total connections per yarn-inch to about 4.2 total connections per yarn-inch, and more preferably about 2.8 total connections per yarn-inch.

In one embodiment, the yarns that form the first layer or the second layer of the composite fabric incorporating the present invention, have at least about 0.02 total connections per filament-inch, and a maximum of about 6.4 total connections per filament-inch. In one preferred embodiment, these yarns have from about 0.022 total connections per filament-inch to about 0.07 total connections per filament-inch, and more preferably about 0.04 total connections per filament-inch.

In one method of making the present invention, the fabric to be further processed is formed and then subjected to a needling process. In one embodiment, the fabric can be a blister fabric which is formed by standard knitting or weaving techniques of filament yarns. The blister fabric includes areas with two separated layers of knitted material, and areas of a double layer jersey knit with yarns from one of the two separated layers sandwiched between the layers of the double layer jersey knit. In another embodiment, the fabric two be processed is two layers that are to be joined in the subsequent processing. At least one of the layers in a multilayer fabric to be processed is a knitted fabric, and both layers could be a knitted fabric. In a preferred embodiment, the yarns forming the fabric to be processed are filament yarns. However, it is contemplated that the yarns could include shorter fibers or could be spun fiber yarns with, or without, filaments.

The formed fabric to be processed is fed into a needling machine that needles the fabric by the insertion of a bed of needles into the fabric. Typically, the needling machine inserts the needles into the fabric, and withdraws the needles, at a direction generally perpendicular to the surface of the fabric. Backing plates provide support to the fabric on the opposite side of the needle bed, and have openings to allow the needles to pass completely through the fabric. The needles can be inserted and withdrawn from either side of the fabric, or both sides of the fabric. By inserting the needles from only one side, connections will only be generated by the side of the fabric to be processed that the needles are inserted. If more needle insertions per square area are required than can be provided by a single insertion of the bed of needles, then the bed of needles can be inserted more than once in a particular area of the fabric, or multiple beds of needles can be used to be inserted into the same area.

In one embodiment, the needling machine inserts the needles into the fabric in a manner that produces little to no relative motion between the beds of needles and the fabric in the linear direction (the machine direction) as the fabric moves into, through, and exits needling machine. The relative linear motion between the needle beds and the fabric can be accomplished by moving the needle beds with the direction of travel of the fabric as the needles are inserted into the fabric and removed from the fabric. After the fabric is needled, a backcoating can be applied to the fabric by various known methods, such as knife coating, foam coating, lamination, spray coating, or other similar methods.

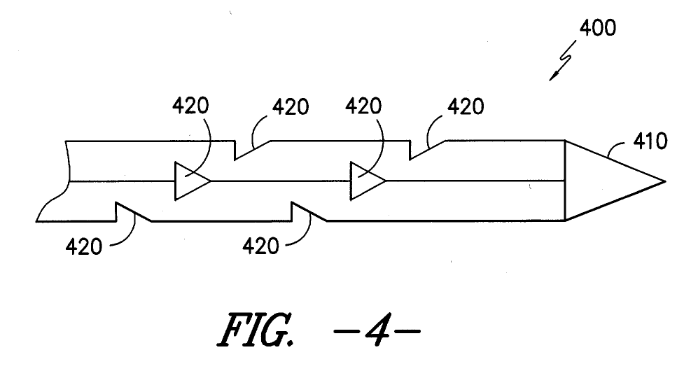

Referring now to FIG. 4, there is shown an enlarged partial view of one embodiment of one of the needles 400 used in the present invention. The needle 400 has a pointed end 410 and notches 420 along the length of the needle 400. The pointed end 410 of the needle 400 facilitates the passage of the needle 400 through the yarns and the fabric layers. The notches 420 of the needle 400 pick up or “hook” fibers of the yarns as the needle 400 passes through the yarns and fabric layers. As the needle 400 continues to pass through adjacent yarns and/or fabric layers, the fibers previously hooked by the notches 420 of the needle 400 are moved into the main body of the adjacent yarns and/or fabric layers. The movement of the fibers by the needle 400 will stretch or pull the fibers from the originating yarns. For fibers with free ends near the needle 400, the fiber will follow the notch 420 of the needle 400 until the free end of the fiber passes through the notch 420 or the needle 400 reaches the end of its travel, and fiber is deposited into the adjacent yarn and/or fabric layer. For other fibers, the fiber will pass into the adjacent yarn and/or layer until the needle 400 reaches the end of its travel, or the tension in the fiber causes the fiber to come free from the notch 420, or the fiber breaks. The portion of the fiber that follows the needle and becomes free from the needle, or breaks, will deposit that portion of the fiber into the adjacent yarn and/or layer.

The result is a positive movement of a portion of the fibers and/or filaments of the yarn directly into the main body of the adjacent yarns and/or fabric layers where those fibers and/or filaments create an anchor directly within the main body of the adjacent yarns and/or fabric layers. The fiber and/or filament left in the adjacent yarn forms the connection between the fabric layers or the yarns of a fabric layer. In contrast, methods such as hydroentanglement force fibers external to the main body of a yarn to entangle with fibers external to another yarn, providing a less direct connection between the two components. Additionally, hydroentanglement has a limited ability to provide stability to a filament yarn fabric because there are no or few free ends of the filaments that can be broken free from the main body of the yarn and/or fabric layer to entangle with the free ends of filaments from other yarns and/or layers.

### EXAMPLE 1

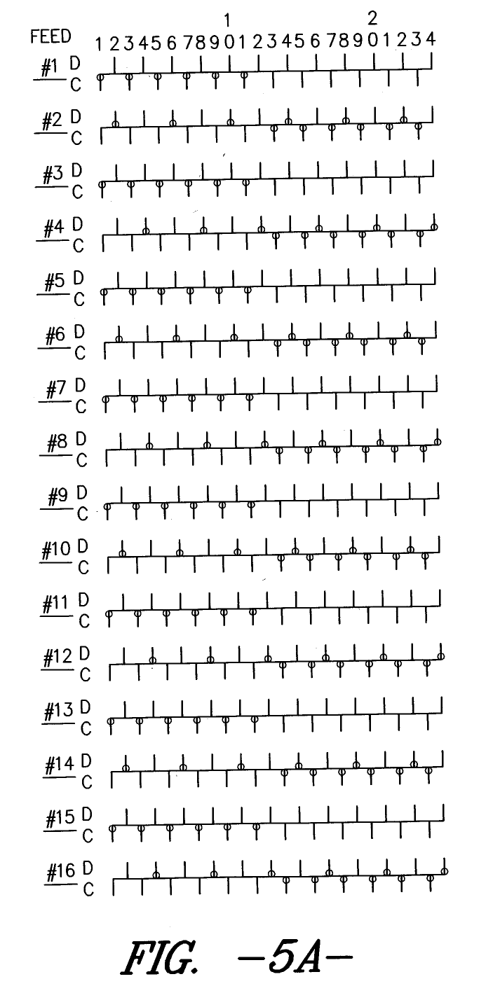

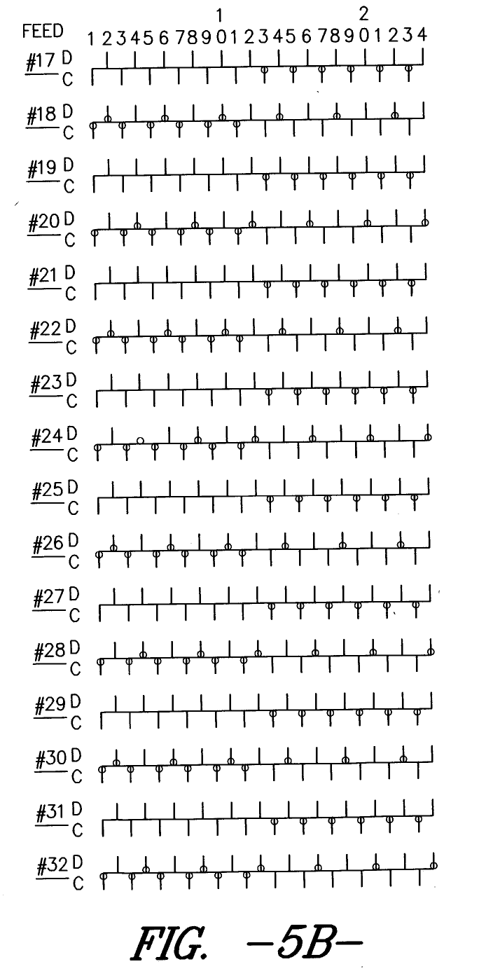

The present invention can be better understood with reference to the following Example. The fabric is a blister fabric formed of two 1/200/48 yarns of different color for the base yarns and 2/150/50 yarns for the blister yarns. The blister fabric is formed on a two bed circular knitting machine with the knitting pattern as shown in FIGS. 5A and 5B. On the back of the fabric, the two base yarns are used to make two different colors knitted in alternate courses, each yarn having about 18 courses per inch each (combined making about 36 courses per inch) and about 13 wales per inch (combined making about 26 wales per inch). The blister yarn does not get knitted in the back of the fabric. On the face of the fabric in the blister zone, the blister yarn forms a jersey knit with about 32 courses per inch and about 28 wales per inch. Also on the face, but in the base area, the two base yarns are knitted in alternate courses, each yarn having about 18.25 courses per inch each (combined making about 36.5 courses per inch) and about 14 wales per inch (combined making about 28 wales per inch).

The blister fabric was then subjected to a needling process to form the connections in the fabric. A Dilo Hyperpunch Double Needle Loom (Dilo Manufacturing Co.) was used to needle the fabric with a needling motion that had little to no relative motion in the machine direction between the fabric and the needle bed. The needle bed contained Groz-Beckert F222 needles, which are a triangular needle with six notches (2 per corner edge of the needle). The needle bed was inserted into the fabric sufficient times that about 900 needle insertions were made per square centimeter of the fabric. It was found that this needling process resulting in about 350 connections per square inch of the fabric in the blister zone, which was about 1.4 connections per yarn inch and about 0.022 connections per filament inch. The needled fabric was then backcoated with about 3 oz/yd² of latex.

The face of the fabric was subjected to the Taber snag testing according to SAE J948, using H-18 wheels with 1000 grams weight for 200 cycles for samples that were not needled, and samples that were needled. For fabric that was not needled, the face of the fabric received a rating of 3.0. For fabric that was needled, the face of the fabric obtained a rating of 3.5.

What is claimed is:

1. A blister fabric comprising:
a plurality of base zone of unitary construction; and,
a plurality of blister zone alternating with the base zones, the blister zones having:
a base layer having base yarn with base yarn fibers; and,
a blister layer having blister yarn with blister yarn fibers;
wherein the base layer and the blister layer are independent layers, and wherein the blister zone further includes:
base layer connections between the base layer and the blister layer by a portion of the base yarn fibers from the base layer; and,
blister layer connections between the blister layer and the base layer by a portion of the blister yarn fibers from the blister layer.

2. A blister fabric comprising:
a plurality of base zone of unitary construction; and,
a plurality of blister zone alternating with the base zones, the blister zones having:
a base layer having base yarn with base yarn fibers; and,
a blister layer having blister yarn with blister yarn fibers;
wherein the base layer and the blister layer are independent layers, and
wherein the blister zone further includes blister layer connections between the blister layer and the base layer by a portion of the blister yarn fibers from the blister layer.

3. A blister fabric comprising:
a plurality of base zone of unitary construction; and,
a plurality of blister zone alternating with the base zones, the blister zones having:
a base layer having base yarn with base yarn fibers; and,
a blister layer having blister yarn with blister yarn fibers;
wherein the base layer and the blister layer are independent layers, and
wherein the blister zone further includes base layer connections between the base layer and the blister layer by a portion of the base yarn fibers from the base layer.
